(19) United States
(12) Patent Application Publication
(10) Pub. No.: US 2010/0259096 A1
(43) Pub. Date: Oct. 14, 2010

(54) Electrohydraulic Brake System for Motor Vehicle

(76) Inventors: Peter Rieth, Eltville (DE); Lothar Schiel, Hofheim (DE); Stefan Drumm, Saulheim (DE)

Correspondence Address: CONTINENTAL TEVES, INC., ONE CONTINENTAL DRIVE, AUBURN HILLLS, MI, 48326-1581, US

(21) Appl. No.: 11/989,853

(22) PCT Filed: Aug. 2, 2006
(86) PCT No.: PCT/EP2006/064986

§ 371 Date: Jun. 17, 2010

(30) Foreign Application Priority Data
Aug. 2, 2005 (DE) 10 2005 036 233.8
Apr. 5, 2006 (DE) 10 2006 015 906.3

(51) Int. Cl. B60T 8/40; B60L 7/26

(52) U.S. Cl. 303/116.1

(57) ABSTRACT

The invention relates to an electrohydraulic brake system for motor vehicles of the ‘brake-by-wire’ type. The brake system comprises among others a travel simulator cooperating with a master brake cylinder and a pressure source consisting of a hydraulic pump and a high-pressure accumulator.

In order to allow deceleration of the vehicle with brake pressures higher than the pressure predetermined in the master cylinder due to the muscular power of the operator upon failure of the electrohydraulic components of the brake system, it is proposed by the invention that a valve assembly (13) is arranged in the connection between the wheel brakes (7, 8, 11, 12) of the vehicle and the pressure source (20 and 21, respectively), which can be actuated both hydraulically by the pressure supplied by the master brake cylinder (2) and by an external force.

The present invention relates to an electrohydraulic brake system for motor vehicles of the ‘brake-by-wire’ type comprising

a master brake cylinder operable by means of a brake pedal and having at least one pressure chamber,

an unpressurized pressure fluid supply tank,

a travel simulator which interacts with the master brake cylinder and imparts the usual feeling at the brake pedal (a pre-selected yieldingness of the brake pedal) to the operator in the ‘brake-by-wire’ mode,

a hydraulic pressure source which is drivable by means of an electronic control and regulation unit, which consists of a hydraulic pump and a high-pressure accumulator chargeable by the pump and the pressure of which can be applied to wheel brakes of the vehicle,

which wheel brakes are connected to the master brake cylinder by means of at least one connection that is closable by a shut-off valve, and associated with which wheel brakes are pressure control valves (inlet valve, outlet valve) being drivable by the electronic control and regulation unit.

An electrohydraulic brake system of this type is disclosed in international patent application WO 03/047936. The prior art brake system includes hydraulic means which, in an emergency or fallback operating mode characterized by failure of electrohydraulic components, use hydraulic pressure prevailing in the high-pressure accumulator to make brake fluid, which has been displaced from the master cylinder into the travel simulator during the previous normal braking operation in the ‘brake-by-wire’ mode, available for a mechanical-hydraulic assist braking operation, in that due to a supply of the high pressure accumulator pressure, controlled by a hydraulic valve, to a hydraulic chamber of the travel simulator, which is connected to the brake fluid supply tank in normal operation, pressure fluid is displaced out of a hydraulic chamber of the travel simulator which is connected to the master cylinder into the master brake cylinder and an auxiliary brake circuit connected thereto, with the result that the wheel brakes are actuated by means of hydraulic pressure, which is predetermined by the muscular power the operator uses when applying the brake pedal. The ergonomic ratios of forces in electrohydraulic brake systems for motor vehicles of the ‘brake-by-wire’ type require, as is known, a layout of the brake system where the wheel brake pressures amount to a multiple of the master cylinder pressure in the normal brake operation.

The fact is considered disadvantageous in the prior art brake system that, upon failure of the electrohydraulic components, braking of the vehicle is possible only with a braking pressure far below the value which is reached in the ‘brake-by-wire’ mode, with the actuating force being the same. Brake force boosting with wheel brake pressures above the pressure which the operator introduces into the master brake cylinder using the brake pedal cannot be achieved without fully operative electrohydraulic components. It is furthermore considered as a shortcoming that the mentioned sudden return delivery of pressure fluid out of the travel simulator into the master brake cylinder causes reactions to the brake pedal which are capable of irritating the operator in addition to the loss of brake force boosting.

In view of the above, an object of the invention is to make available a reliably functioning brake system of the type mentioned hereinabove, i.e. to disclose a brake system which provides another fallback operating mode that permits braking the vehicle upon failure of the electrohydraulic components with braking pressures being higher than the pressure in the master brake cylinder that is predetermined by the muscular power of the operator.

According to the invention, this object is achieved in that a valve assembly is arranged in the connection between the wheel brakes and the pressure source, which can be actuated both hydraulically by the pressure supplied by the master brake cylinder and by an external force. Preferably, the valve assembly furnishes an analog-controllable hydraulic braking pressure which can be applied to the wheel brakes.

To render the idea of the invention more precise, it is proposed to use an electric actuator for generating the external force.

In another favorable design variation of the object of the invention, electrohydraulic means is provided to generate the external force, delivering an electrically analog-controllable pressure. This is advantageous because the setting energy for the provision of the external force is taken from the high-pressure accumulator, avoiding major fluctuations in the electric power consumption of the electronic control and regulation unit.

In a favorable improvement of the subject matter of the invention, the electrohydraulic means are analog-controllable solenoid valves which are connected hydraulically to the pressure source and the pressure fluid supply tank. These controllable solenoid valves have stood the test already as brake system components. They are contained also in the prior art brake system, at a different location and in a different function though.

Another favorable improvement of the subject matter of the invention arranges that the actuation of the valve assembly takes place by means of an actuating element which is in a force-transmitting connection with a valve member of the valve assembly. A hydraulically active cross-sectional surface of the actuating element defines the proportionality factor between the master brake cylinder pressure and the transmitted valve actuating force.

The valve assembly is configured as a slide valve in another favorable embodiment of the invention. Due to its one-part design, the slide valve is preferred over other types of constructions of valves with valve seats and combinations of valve seat and control edges in the type of construction of slides, which also lend themselves to being readily employed in this position.

The above-mentioned actuating element is designed as a hydraulic piston in another embodiment of the object of the invention, which piston can be acted upon both by the pressure provided by the master brake cylinder and by the electrically controllable pressure. The hydraulic piston preferably delimits a hydraulic chamber, to which any of the available pressures can be applied. When the electrically analog-controllable pressure is supplied, the brake system operates in the ‘brake-by-wire’ operating mode, while it operates as a brake system with a purely hydraulic boosting arrangement when supplying the master cylinder pressure in the mentioned fallback operating mode.

In another expedient improvement of the invention, a shuttle valve is inserted into the connections between the master brake cylinder and the hydraulic chamber and between the electrohydraulic means and the hydraulic chamber, which shuttle valve is actuated by a difference in pressure between pressure furnished by the master brake cylinder and the electrically controllable pressure.

In this arrangement, the hydraulic actuation of the shuttle valve is carried out in such a fashion that the respectively higher pressure is applied to the hydraulic chamber. Thus, an automatic change-over between the ‘brake-by-wire’ operating mode and the hydraulically boosted operating mode takes place in such a way that the respectively higher braking pressure requirement will prevail.

Another favorable design version of the object of the invention provides that the hydraulic piston is designed as a stepped piston whose annular surface can be acted upon by the pressure furnished by the master brake cylinder, while the electrically analog-controllable pressure can act on the piston surface of small diameter. This variant obviates the need for a shuttle valve for selection of the respectively higher wheel braking pressure requirement.

On the other hand, the above-mentioned hydraulic chamber is delimited by an additional piston biased by means of a spring, whose movement in opposition to the force of the spring allows volume absorption for the pressure fluid delivered by the electrohydraulic means. Such volume absorption improves the control quality of the electrohydraulic pressure control in the ‘brake-by-wire’ operating mode.

Another advantageous embodiment of the object of the invention arranges that shuttle valves are inserted into the connections between the master brake cylinder and the wheel brakes and between the valve assembly 13 and the wheel brakes, which shuttle valves are actuated by a difference in pressure between the pressure furnished by the master brake cylinder and the analog-controllable hydraulic braking pressure output by the valve assembly 13 and which connect the master brake cylinder to the wheel brakes in a first switch position and connect the outlet of the valve assembly to the wheel brakes in a second switch position.

In order to perform especially the decrease of the wheel braking pressures which is required for so-called recuperation brake operations in hybrid vehicles to values below the master cylinder pressure, it is finally provided that electrically actuatable two-way/two-position directional control valves are inserted into the hydraulic connections between the master cylinder and the wheel brakes, the said valves when activated preventing an exchange of pressure fluid between the master brake cylinder and the wheel brakes as well as between the master brake cylinder and the valve assembly.

Further details, features and advantages of the invention can be taken from the following description of four embodiments making reference to the accompanying drawings. In the drawings, in which like parts have been assigned like reference numerals:

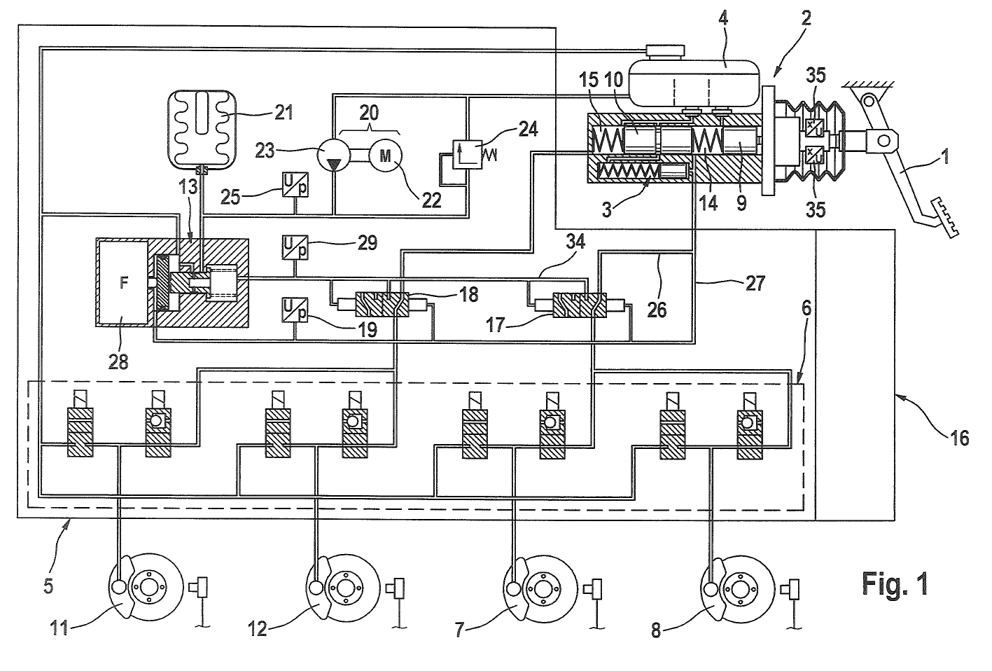

FIG. 1 shows the layout of a first embodiment of the brake system of the invention in the non-actuated and de-energized state;

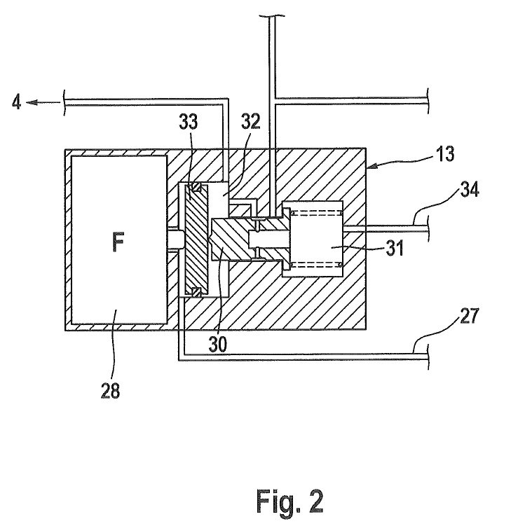

FIG. 2 is a greatly enlarged view of the valve assembly shown in FIG. 1;

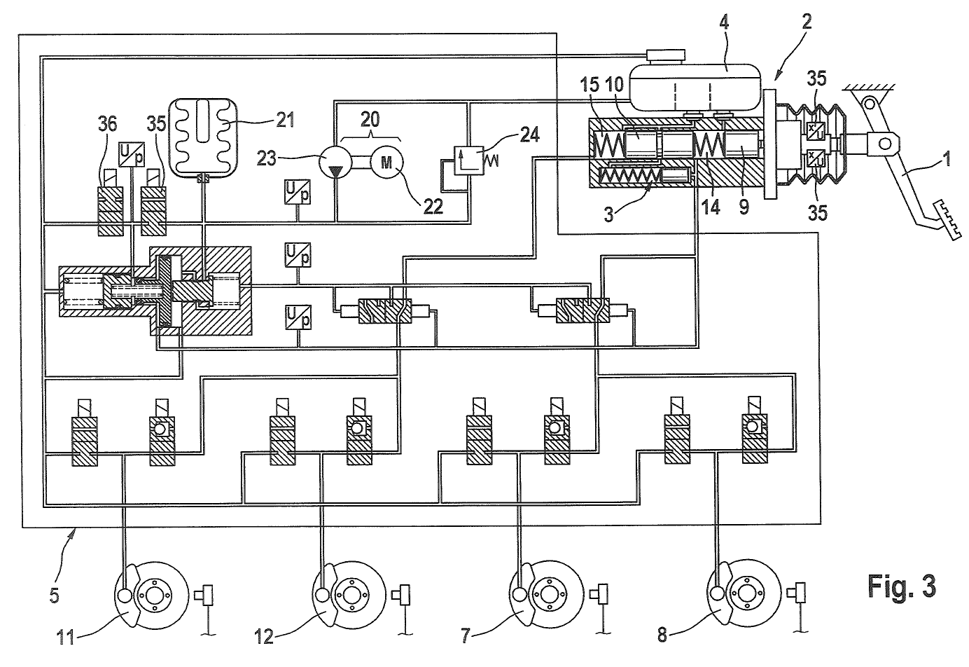

FIG. 3 shows the layout of a second embodiment of the brake system of the invention in the non-actuated and de-energized state;

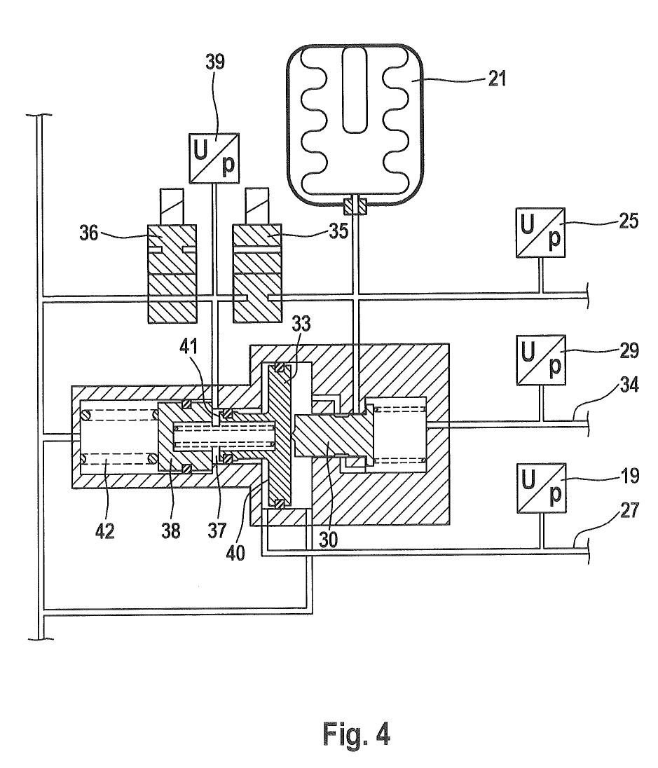

FIG. 4 is a greatly enlarged view of the valve assembly shown in FIG. 3;

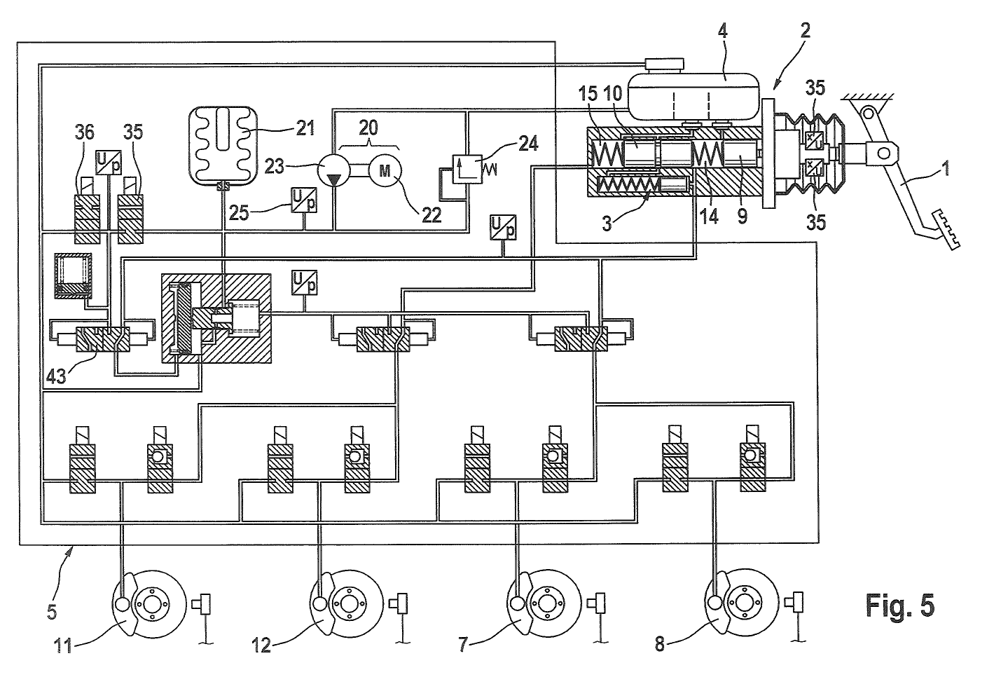

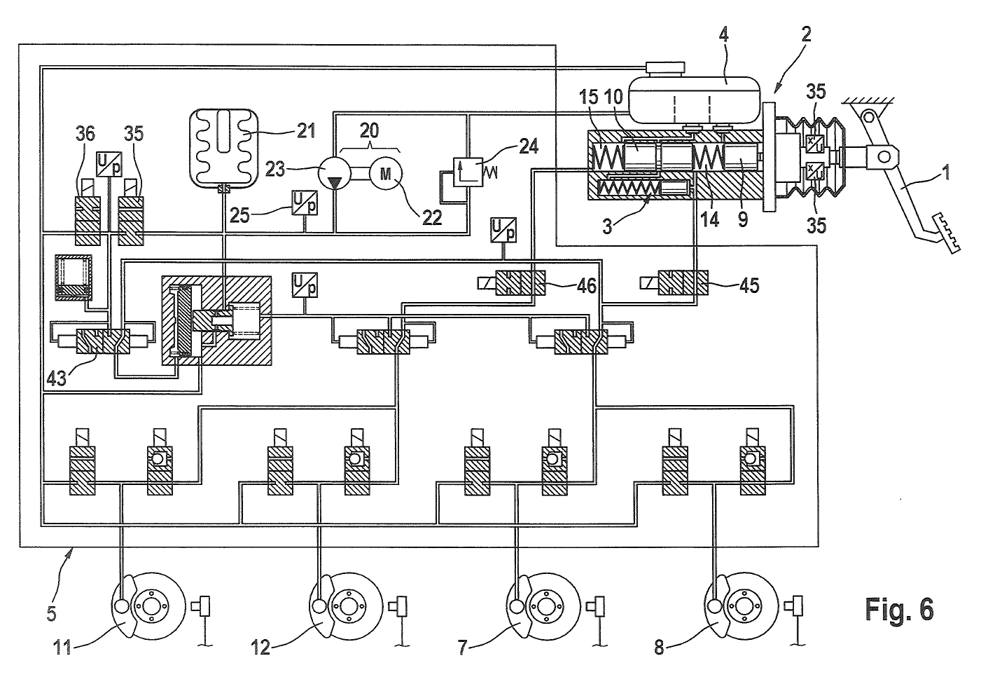

FIGS. 5 and 6 show the layout of a third and a fourth embodiment of the brake system of the invention in the non-actuated and de-energized state; and

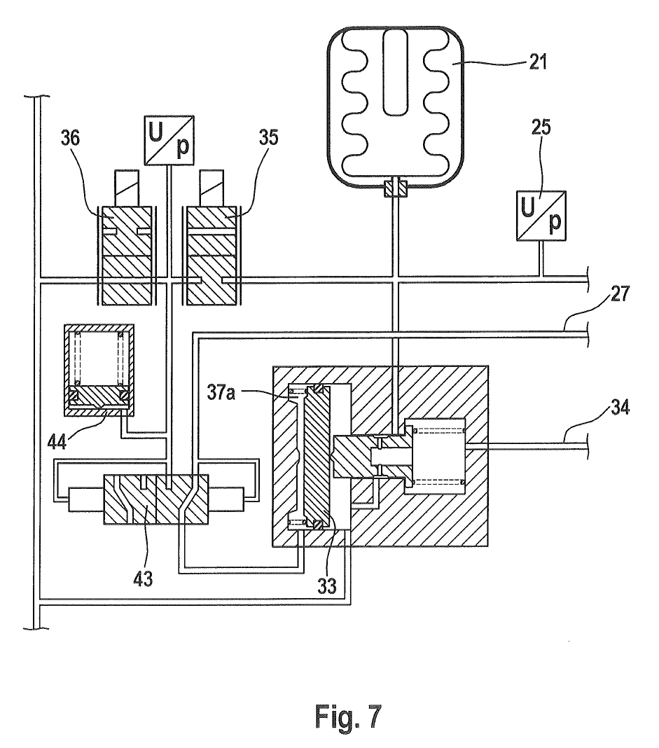

FIG. 7 is a greatly enlarged view of the valve assembly shown in FIGS. 5 and 6.

The electrohydraulic brake system depicted in a diagrammatic representation only is basically composed of a dual-circuit hydraulic pressure generator or master brake cylinder 2 in tandem design being operable by means of a brake pedal 1, a travel simulator 3 cooperating with the tandem master cylinder 2, a pressure fluid supply tank 4 associated with the tandem master cylinder 2, a schematically illustrated hydraulic module 5 to which wheel brakes 7, 8, 11, 12 associated with the vehicle wheels are connected, as well as an electronic control and regulation unit 16. Integrated into the hydraulic module 5 are a pressure source, a hydraulic control unit HCU 6, containing all components or pressure control valves required for wheel-individual pressure control operations, a valve assembly furnished with reference numeral 13 and two shuttle valves 17, 18 whose task will be explained in the following. Wheel sensors which are only indicated yet not referred to in detail are used to determine the rotational speed of the vehicle wheels. The per se known tandem master cylinder 2 includes two pressure chambers 14, 15 isolated from each other and delimited by two pistons 9, 10, the pressure chambers being connectable both to the pressure fluid supply tank 4 and to the vehicle brakes 7, 8, 11, 12 via the HCU 6. The above-mentioned pressure source is constituted of a motor-and-pump aggregate 20 comprising an electric motor 22 and a pump 23 driven by the electric motor 22, a pressure-limiting valve 24 connected in parallel to the pump 23, and a high-pressure accumulator 21 being chargeable by the pump 23. A pressure sensor 25 monitors the hydraulic pressure prevailing in the high-pressure accumulator 21.

The above-mentioned valve assembly 13 which is designed as a slide valve in the example shown is interposed between the pressure source 20, 21 and the wheel brakes 7, 8, 11, 12 in terms of effect and is actuated by an electromechanical actuator 28, on the one hand, and by the hydraulic pressure introduced into the first pressure chamber 14 of the master brake cylinder 2, on the other hand.

As can also be seen in the drawings, the wheel brakes 7, 8 connect to the first pressure chamber 14 by way of a conduit 26, into which the first shuttle valve 17 is inserted which connects the first pressure chamber 14 to the wheel brakes 7, 8 in a first switch position and, in a second switch position, connects the outlet of the valve assembly 13 to the wheel brakes 7, 8, with conduit 26 being interrupted simultaneously. Branching off in front of the shuttle valve 17 is another conduit 27 that leads to the valve assembly 13 and serves for the hydraulic actuation of the valve assembly 13. It is discernible from FIG. 1 that the shuttle valve 17 is actuated by a difference in pressure between the pressure furnished by the master brake cylinder 2 and the hydraulic brake pressure that is analog-controllable by the valve assembly 13. This actuation of the shuttle valve 17 is performed in such a fashion that the respectively higher pressure is applied to the wheel brakes 7, 8. The pressure introduced into the first pressure chamber 14 is monitored by means of a pressure sensor 19, while the pressure supplied by the valve assembly 13 is sensed by means of a pressure sensor 29. Accordingly, the above explanations apply also to the second pressure chamber 15, the second shuttle valve 18 and the wheel brakes 11, 12 connected to the second pressure chamber 15.

The electronic control and regulation unit 16 which has been referred to before and to which are sent the output signals of the pressure sensors 19, 25, 29, of the wheel rotational speed sensors and a braking request detecting device 35 of a preferably redundant design that is associated with the master brake cylinder 2, serves for driving the motor-and-pump aggregate 20, the actuator 28 and the hydraulic control unit HCU 6.

As can be gathered from FIG. 2 in particular, the valve assembly 13 includes a valve member 30 enabling, in the switch position shown, a hydraulic connection between an output chamber 31, which is connected to an inlet port of the shuttle valve 17 by way of a conduit 34, and a hydraulic chamber 32 which is in communication with the pressure fluid supply tank 4. Chamber 32 is delimited by a hydraulic piston 33 which, on the one hand, as has been explained already hereinabove, is loaded through conduit 27 by the pressure introduced into the master brake cylinder 2 and, on the other hand, is in a force-transmitting connection to the electromechanical actuator 28.

In the design shown in FIGS. 3 and 4, the valve assembly 13 mentioned with respect to FIGS. 1 and 2 in addition to the hydraulic actuation by the master brake cylinder 2 is driven by electrohydraulic means which are formed of electrically drivable, analog-controllable two-way/two-position directional control valves 35, 36 in the illustrated example. The two-way/two-position directional control valve 35 connected to the outlet of the pressure source 20 or 21 is configured as a normally closed (NC) valve, while the other two-way/two-position directional control valve 36 is configured as a normally open (NO) valve. The outlet side of the first mentioned valve 35 and the inlet side of the second mentioned valve 36 communicates with a hydraulic chamber 37 which is delimited by the piston 33, on the one hand, and by an additional piston 38, on the other hand. An additional pressure sensor 39 monitors the pressure in chamber 37 that is electrically analog-controllable by the valves 35, 36. As can be seen especially in FIG. 4, the piston 33 is designed as a stepped piston whose annular surface 40 is acted upon by the pressure furnished by the master brake cylinder 2, while the pressure that is electrically analog-controllable by the two-way/two-position directional control valves 35, 36 acts on the piston's surface 41 of small diameter. The other piston 38 is biased by means of a compression spring 42, and its movement in opposition to the force of spring 42 permits increase of the hydraulic chamber 37 and thus take-up of the pressure fluid volume made available by valves 35, 36.

In the embodiments shown in FIGS. 5 to 7, a shuttle valve 43 is inserted into the conduit between the analog-controllable two-way/two-position directional control valves 35, 36 and the chamber 37a delimited by the piston 33 (see FIG. 7), which shuttle valve is operable by a difference in pressure between the pressure furnished by the master brake cylinder 2 and the electrically analog-controllable hydraulic pressure output by the electrohydraulic means 35, 36. Actuation of the shuttle valve 43 is such that the respectively higher pressure is applied to the piston 33. Further, a volume take-up element 44 is connected to the above-mentioned conduit.

In order to set braking pressure which is lower than the pressure value that corresponds to the driver's deceleration request, in the embodiment illustrated in FIG. 6 two normally open (NO) two-way/two-position directional control valves 45, 46 connected to the pressure chambers 14, 15 of the master brake cylinder 2 are connected, preventing upon activation an exchange of pressure fluid between the master brake cylinder 2 and the wheel brakes 7, 8, 11, 12 as well as between the master brake cylinder 2 and the valve assembly 13. A brake system of this type is employed in particular in vehicles with an additional recuperation brake (so-called hybrid vehicles).

1. Electrohydraulic brake system for motor vehicles of the ‘brake-by-wire’ type comprising
a master brake cylinder operable by means of a brake pedal and having at least one pressure chamber,
an unpressurized pressure fluid supply tank,
a travel simulator which interacts with the master brake cylinder and imparts the usual feeling at the brake pedal (a pre-selected yieldingness of the brake pedal) to the operator in the ‘brake-by-wire’ mode,
a hydraulic pressure source which is drivable by means of an electronic control and regulation unit, which consists of a hydraulic pump and a high-pressure accumulator chargeable by the pump and the pressure of which can be applied to wheel brakes of the vehicle,
which wheel brakes are connected to the master brake cylinder by means of at least one connection that is closable by a shut-off valve, and associated with which wheel brakes are pressure control valves (inlet valve, outlet valve) being drivable by the electronic control and regulation unit,
characterized in that a valve assembly (13) is arranged in the connection between the wheel brakes (7, 8, 11, 12) and the pressure source (20 and 21, respectively), which can be actuated both hydraulically by the pressure supplied by the master brake cylinder (2) and by an external force.

2. Electrohydraulic brake system as claimed in claim 1,
characterized in that the valve assembly (13) furnishes an analog-controllable hydraulic braking pressure which can be applied to the wheel brakes.

3. Electrohydraulic brake system as claimed in claim 1,
characterized in that an electric actuator (28) is provided to generate the external force.

4. Electrohydraulic brake system as claimed in claim 1,
characterized in that electrohydraulic means (35, 36) is provided to generate the external force, delivering an electrically analog-controllable pressure.

5. Electrohydraulic brake system as claimed in claim 1,
characterized in that the electrohydraulic means are analog-controllable solenoid valves (35, 36) which are connected hydraulically to the pressure source (20 and 21, respectively) and the pressure fluid supply tank (4).

6. Electrohydraulic brake system as claimed in claim 2,
characterized in that the actuation of the valve assembly (13) is carried out by means of an actuating element (33) which is in a force-transmitting connection with a valve member (30) of the valve assembly (13).

7. Electrohydraulic brake system as claimed in any one of claims 1 to 6,
characterized in that the valve assembly (13) is configured as a slide valve.

8. Electrohydraulic brake system as claimed in claim 6 or 7,
characterized in that the actuating element (33) is designed as a hydraulic piston which can be acted upon both by the pressure provided by the master brake cylinder (2) and by the electrically analog-controllable pressure.

9. Electrohydraulic brake system as claimed in claim 8,
characterized in that the hydraulic piston delimits a hydraulic chamber (37), to which any of the available pressures can be applied.

10. Electrohydraulic brake system as claimed in claim 9,
characterized in that a shuttle valve (43) is inserted into the connections between the master brake cylinder (2) and the hydraulic chamber (37) and between the pressure source (20 and 21, respectively) and the hydraulic chamber (37a), which shuttle valve is actuated by a difference in pressure between the pressure furnished by the master brake cylinder (2) and the electrically analog-controllable pressure.

11. Electrohydraulic brake system as claimed in claim 10,
characterized in that the actuation of the shuttle valve (43) is carried out in such a fashion that the respectively higher pressure is applied to the hydraulic chamber (37a).

12. Electrohydraulic brake system as claimed in any one of claims 8 to 11,
characterized in that the hydraulic piston (33) is designed as a stepped piston whose annular surface (40) is acted upon by the pressure furnished by the master brake cylinder (2), while the electrically analog-controllable pressure acts on the piston surface (41) of small diameter.

13. Electrohydraulic brake system as claimed in any one of claims 9 to 12,
characterized in that the hydraulic chamber (37) is delimited by an additional piston (38) biased by means of a spring (42), whose movement in opposition to the force of the spring (42) allows volume absorption for the pressure fluid delivered by the electrohydraulic means (35, 36).

14. Electrohydraulic brake system as claimed in any one of the preceding claims,
characterized in that shuttle valves (17, 18) are inserted into the connections (26, -) between the master brake cylinder (2) and the wheel brakes (7, 8, 11, 12) as well as between the valve assembly (13) and the wheel brakes (7, 8, 11, 12), which shuttle valves are actuated by a difference in pressure between the pressure furnished by the master brake cylinder (2) and the analog-controllable hydraulic braking pressure delivered by the valve assembly (13) and which connect the master brake cylinder (2) to the wheel brakes (7, 8, 11, 12) in a first switch position and connect the outlet of the valve assembly (13) to the wheel brakes (7, 8, 11, 12) in a second switch position.

15. Electrohydraulic brake system as claimed in any one of the preceding claims,
characterized in that electrically actuatable two-way/two-position directional control valves (45, 46) are inserted into the hydraulic connections between the master cylinder (2) and the wheel brakes (7, 8, 11, 12), the said valves when activated preventing an exchange of pressure fluid between the master brake cylinder (2) and the wheel brakes (7, 8, 11, 12) as well as between the master brake cylinder (2) and the valve assembly (13).
